(19) United States
(12) Patent Application Publication
(10) Pub. No.: US 2003/0210277 A1
(43) Pub. Date: Nov. 13, 2003

(54) Ordering service system at restaurant or the like

(76) Inventor: Toshihiko Harada, Tokyo (JP)

Correspondence Address: DUANE MORRIS LLP, Suite 700, 1667 K Street, N.W., Washington, DC, 20006, US

(21) Appl. No.: 10/420,836

(22) Filed: Apr. 23, 2003

Related U.S. Application Data
(63) Continuation-in-part of application No. 09/704,524, filed on Nov. 3, 2000.

(51) Int. Cl. G09G 5/00

(52) U.S. Cl. 345/810

(57) ABSTRACT

An ordering service system at a restaurant provided with an ordering device having a touch panel type display for inputting food menu contents and seasonal menu content that are displayed thereon with moving images. The ordering device also displays extraneous amusement or information content, apart from the food ordering content, supplied with a charge or free of charge though a network such as the Internet. The ordering system includes a management computer for receiving ordered contents by way or without resort to an order server computer presenting the ordered data, charge and table number at least to the user by printing out the order and feeding the ordered data into a cashier's register thereby resulting in a user friendly ordering system.

### RELATED APPLICATIONS

This is a continuation-in-part of application Ser. No. 09/704,524 filed Nov. 3, 2000.

### BACKGROUND

The present invention relates to an ordering service system at a restaurant or other eating place for allowing a user to order the desired food by touching a touch panel displaying a food menu at their own table, displaying the order slip for confirmation of order and charges and selectively displaying free or charged extraneous services that are extraneous to the food service of the food service of the restaurant on the touch panel while waiting until the ordered food is brought to the table. The ordering service system also includes process confirmation by the user to improve Quality Assurance.

In a hitherto known system at a restaurant or the like, when ordering food or drink, the order is entered from a hand-held input terminal, and the data is sent to the kitchen, and is also entered into a register 9 as cashier data.

However, this system is rational in that the user's order information is simultaneously supplied into the kitchen and the cashier, but the user has to wait only at the table until the ordered food is brought in, and in this respect there is no change from the conventional hand-writing slip ordering system, and there is no improvement about the waiting time for the user.

It is hence an object of the invention to present an ordering service system at a restaurant or the like for allowing the user to kill the waiting time effectively by selecting the free or charged extraneous services, making use of the screen, while waiting until the ordered food is brought in, after ordering the desired food by the touch panel as seated at a vacant table.

It is further an object to present an ordering service system at a restaurant by providing user tables at the restaurant with order input means of touch panel type. An order input is executed by the user from the input means into a management computer by way of or without resort to an order server computer. The management computer presenting the order data of order menu, charge and table number at least to the user by printing out, and also feeding the order data into a cashier's register. The input means displays the food menu contents by moving image, and displays free or charged extraneous services using a computer network, thereby allowing the user to select one of these displays. The input means includes an order for food complete selection, that when engaged by touching the selection, a server computer provides the user at the table with an order slip and displays the contents of the order slip on the display unit.

It is another object to present an ordering service system at a restaurant by providing user tables at the restaurant with order input means of touch panel type. An order input is executed by the user from the input means into a management computer by way of or without resort to an order server computer. The management computer presenting the order data of order menu, charge and table number at least to the user by printing out, and also feeding the order data into a cashier's register. The input means displays the food menu contents by moving image, and displays free or charged extraneous services using a computer network, thereby allowing the user to select one of these displays. The input means includes an order charge request selection, that when engaged by touching the selection, a server computer provides the user at the table with an order charge slip. The display unit displays the order charge slip for confirmation.

It is an additional object to present an ordering service system at a restaurant. The ordering system including input means. The input means including an order for food complete selection, that when engaged by touching the selection, a server computer provides the user at the table with an order slip. The imput means also including an order charge request selection, that when engaged by touching the selection, a server computer provides the user at the table with an order charge slip, wherein the content of the order slip and order charge slip are displayed separately by the display means.

To achieve the objects, the present invention provides an ordering service system at restaurant or the like characterized by providing user tables at a restaurant or the like with order input means of touch panel type, entering an order input executed by the user from this input means into a management computer by way of or without resort to an order server computer, presenting the order data such as order menu, charge and table number to the user by printed order slip and or order charge slip and displaying the same for confirmation, and also feeding the order data and or order charge data to a food preparation location and into a cashier's register, in which the input means (a) displays the food menu contents by moving images specifically, live Action displays of the prepared food items, (b) displays season menu, and (c) displays free or charged extraneous services using a network such as Internet, thereby allowing the user to select one of these displays.

### BRIEF DESCRIPTION OF THE DRAWING

FIG. 1 is a block diagram for explaining a system of the present invention.

### DESCRIPTION OF THE PREFERRED EMBODIMENTS

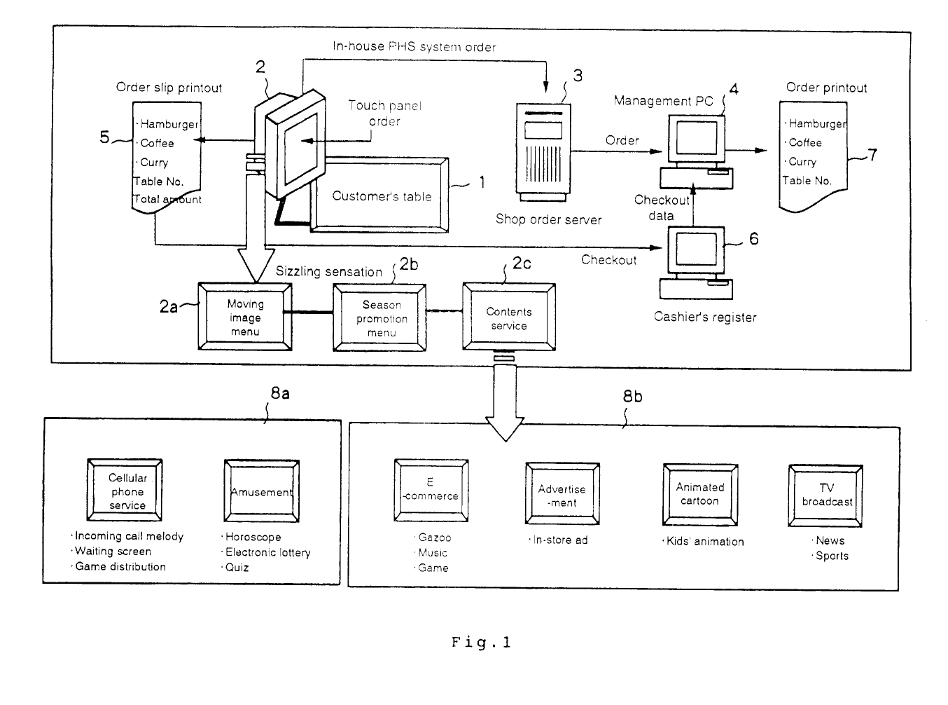

An embodiment of the system of the invention is described by referring to the drawing. FIG. 1 is a block diagram showing an example of an ordering system of the present invention.

In FIG. 1, reference numeral 1 is a table at a restaurant or the like, and usually a plurality of tables are arranged in a proper layout according to the area of the eating place, but only one table is shown here for the sake of simplicity of explanation. Reference numeral 2 is a display unit composed of CRT (cathode-ray tube), liquid crystal panel, or the like, having a terminal computer incorporated inside, and its screen surface is a touch panel, and when a corresponding point on the display menu is touched, the screen is changed over to a detailed display, or when the food menu is being displayed on the screen, by touching a desired food menu item, for example, the cooking scene of the food along with the prepared menu item, is displayed in moving image or still image, and by touching the screen of the desired food on the menu display and pressing the OK button, or order for food complete selection the dish is ordered, and the order data is processed as described below.

Reference numeral 3 is an order server computer for receiving the order information (order data) by touch panel operation of the display unit 2, transferring it to a management computer 4, and printing out an order slip 5. This server computer 3 sums up the order contents at a specific table 1, and transfers to the management computer 4, also prints out the order slip 5 to the user at the table 1 to confirm the order contents and/or printing out the order charge slip to the user at table 1 to confirm charge amount. Upon printing out the order slip, and or order charge slip, the contents of the slip are displayed on the display unit, at which time a confirmation of the order or charge order may be requested of the user with his or her intended order and with the displayed order slip or charge order. The same information as the order slip 5 or order charge slip is supplied from the management computer 4 to a cashier's register 6 as the checkout data. From the management computer 4, after confirmation of the order by the user if desired or after a predetermined time duration selected by restaurant personnel, the food data such as name and quantity of ordered menu items including the table number is printed out as kitchen data 7, at the food preparation location, for example, in each type of menu. If challenged, the order is not sent to the kitchen data and a challenge message is sent to alert the restaurant personnel the order is incorrect, whereby a new order can be taken.

The user can confirm order and/or order charge by touching an appropriate labeled confirmation order display on the display unit or challenge the order by touching an appropriate labeled challenge order display on the display unit. The default status entered by the computer terminal after the expiration of a management determined time duration implemented by timer in the system is preferably set to confirm, however, a challenge default entry is likewise envisioned where users abandon orders frequently.

The screen of the display unit 2 includes a menu screen 2a as mentioned above, a season menu screen 2a, and a choice contents menu screen 2c showing free and charged extraneous services, and when one of the screens 2a to 2c of the display menu of the display unit 2 is touched and selected, the selected display menu appears on the screen.

Of these screens, the screens 2a and 2b are food menu screens, but when the contents menu screen 2c is selected, a charged extraneous service menu screen 8a and a free extraneous service menu screen 8b appear on the display unit 2, and the user seated at the table 1 can select the desired menu screen 8a or 8b. The charged extraneous service menu screen 8a includes, for example, cellular phone service contents such as “incoming call melody”, “waiting screen”, and “game distribution”, or amusement contents such as “horoscope”, “electronic lottery” and “quiz”, so that the user can select desired contents. If not desired to use charged contents, the user does not touch the screen.

On the other hand, the free extraneous service menu screen 8b includes, for example, “e-commerce”, “advertisement”, “animated cartoon broadcast”, “TV program”, and other free contents, so that the user can select desired contents menu by touching the menu screen, so that the selected contents are displayed, and the user can kill the time until the ordered food is distributed by viewing the screen or listening to the music. The contents menu can be freely determined by the owner according to the requests and opinions of the users.

In this process, when charged extraneous services are selected, at the moment of selection of the charged extraneous services, that is, ordering of the charged extraneous service, once the information is accumulated in the server computer 3, and then transferred to the management computer 4. The account of using the charged extraneous services is executed at the cashier's register 6 at the time of checkout. In the invention, therefore, the food order and charged extraneous service orders are printed out on the order charge slip 5 by touching the display of “final checkout” or order charge request selection on the display unit 2, by the terminal computer incorporated in the display unit 2, as before, the order charge slip is displayed by the display unit and printed by the management computer for the user and confirmation of the order charge slip displayed with the actual order or the printed order slip may be requested of the user using the confirm or challenge selections or automatically confirmed by passage of the predetermined duration of time. If the order is confirmed, the user has only to pay the charged amount (settle) at the cashier by presenting the order charge slip 5. Otherwise, a challenge message is sent by the terminal computer to the management computer as to alert restaurant personnel to the challenged order slip and prevent further processing of the order charge. The restaurant personnel using an override mechanism can then dismiss the challenge, in which case the previous order slip is confirmed, or settle the challenge with a modified order charge slip in which the process is continued.

According to the invention, as described herein, the user has only to select the desired menu and touch the screen 2, and the order menu information is sent to the computer, and processed as settlement data and kitchen data, both subject to confirmation by the user and the attending clerks such as waiters and waitresses are not needed, and the labor cost and training cost are saved, and moreover advertisement fees are obtained from sponsors contacting about the contents presented through the display screen, and moreover when e-commerce is utilized, the commission charges and contents sales revenues are expected, and the economic effects are tremendous. In particular, when the menu display 5 screen terminal and server computer are built up by an in-house PHS system, the system of this invention can be realized at a low cost.

Further, when the food menu is displayed by moving image, the information of sizzling food can be presented to the user, and the seasonal menu can be timely presented to the user, or for family users, it adds an extra merit of presenting exciting games to children during waiting for the ordered food.

What is claimed is:

1. An ordering service system at a restaurant characterized by providing user tables at the restaurant with order input means of touch panel type, entering an order input executed by the user from the input means into a management computer by way of or without resort to an order server computer, presenting the order data of order menu, charge and table number at least to the user by printing out, and also feeding the order data into a cashier's register, wherein the input means displays the food menu contents by moving image, and displays free or charged extraneous services using a computer network, thereby allowing the user to select one of these displays, wherein the input means includes an order for food complete selection, that when engaged by touching the selection, a server computer provides the user at the table with an order slip.

2. The ordering service system according to claim 1, wherein the content of the order slip is displayed on the display means.

3. The ordering service system according to claim 2, wherein the input means includes an order data confirmation selection, that when touched confirms the order and allows the order data to be printed out or displayed as kitchen data at a food preparation location.

4. The ordering service system according to claim 3, wherein the input means includes an order data challenge selection that when touched challenges the order data and sends a challenge message to the management computer, the management computer blocks the transfer of order data to the cashiers register and as kitchen data.

5. The ordering service system according to claim 4, wherein the management computer includes a manual override allowing restaurant personnel to confirm the order data or change the order data.

6. The ordering system according to claim 4, wherein the input means includes a timer with a predetermined time duration, that when the duration expires is selectively set to confirm or challenge the order data.

7. An ordering service system according to claim 1, wherein the charged extraneous services are cellular phone services or amusement services.

8. An ordering service system according to claim 7, wherein the amusement services are horoscopes, an electronic lottery or quiz.

9. (previously added) An ordering service system according to claim 1, wherein the free extraneous services are e-commerce, advertisement, cartoons, or television programs.

10. (previously added) An ordering service system according to claim 1, wherein the order input means is a touch screen.

11. (previously added) An ordering service system according to claim 1, wherein the input means displays a season menu.

12. An ordering service system at a restaurant characterized by providing user tables at the restaurant with order input means of touch panel type, entering an order input executed by the user from the input means into a management computer by way of or without resort to an order server computer, presenting the order data of order menu, charge and table number at least to the user by printing out, and also feeding the order data into a cashier's register, wherein the input means displays the food menu contents by moving image, and displays free or charged extraneous services using a computer network, thereby allowing the user to select one of these displays, wherein the input means includes an order charge request selection, that when engaged by touching the selection, a server computer provides the user at the table with an order charge slip.

13. The ordering service system according to claim 12, wherein the content of the order charge slip is displayed on the display means.

14. The ordering service system according to claim 13, wherein the input means includes an order charge data confirmation selection, that when touched confirms the order charge and allows the order data to be sent to the cashiers register.

15. The ordering service system according to claim 14, wherein the input means includes an order charge data challenge selection that when touched challenges the order data and sends a challenge message to the management computer, the management computer blocks the transfer of order charge data to the cashiers register.

16. The ordering service system according to claim 14, wherein the management computer includes a manual override allowing restaurant personnel to confirm the order charge data or change the order charge data.

17. The ordering system according to claim 15, wherein the input means includes a timer with a predetermined time duration, that when the duration expires is selectively set to confirm or challenge the order charge data.

18. An ordering service system at a restaurant characterized by providing user tables at the restaurant with order input means of touch panel type, entering an order input executed by the user from the input means into a management computer by way of or without resort to an order server computer, presenting the order data of order menu, charge and table number at least to the user by printing out, and also feeding the order data into a cashier's register, wherein the input means displays the food menu contents by moving image, and displays free or charged extraneous services using a computer network, thereby allowing the user to select one of these displays, wherein the input means includes an order for food complete selection, that when engaged by touching the selection, a server computer provides the user at the table with an order slip and the input means includes an order charge request selection, that when engaged by touching the selection, a server computer provides the user at the table with an order charge slip, wherein the content of the order slip and order charge slip are displayed separately of the display means.

19. The ordering service system according to claim 18, wherein the input means includes an order data confirmation selection and an order charge data confirmation selection, wherein touching the order data confirmation selection confirms the order and allows the order data to be printed out or displayed as kitchen data at a food preparation location and wherein touching the order charge data confirmation selection confirms the order charge data and allows the order charge data to sent to the cashiers register.

20. The ordering service system according to claim 19, wherein the input means includes an order data challenge selection that when touched challenges the order data and sends a challenge message to the management computer, the management computer blocks the transfer of order data to the cashiers register and as kitchen data, and the input means includes an order charge data challenge selection that when touchéchallenges the order charge data and sends a order charge challenge message to the management computer, the management computer upon receipt order charge challenge message blocks the transfer of the order charge data to the cashiers register.
